(19) United States
(12) Patent Application Publication
(10) Pub. No.: US 2008/0161446 A1
(43) Pub. Date: Jul. 3, 2008

(54) Moulded Body with Light Scattering Properties

(75) Inventor: Werner Siol, Darmstadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Evonik Roehm GmbH, Darmstadt (DE)

(21) Appl. No.: 11/997,239

(22) PCT Filed: Aug. 17, 2006
(86) PCT No.: PCT/EP2006/065383

§ 371 Date: Jan. 29, 2008

(30) Foreign Application Priority Data
Sep. 1, 2005 (DE) 10 2005 041 402.8

(51) Int. Cl. C08L 33/02; C08L 33/08; C08L 33/10

(52) U.S. Cl. 523/201; 525/221

(57) ABSTRACT

The invention relates to mouldings comprising a transparent plastic matrix with small proportions of incorporated, very finely divided plastic particles which have a particle diameter less than the wavelength of visible light, and to the use of these mouldings for visualizing laser beams and for illumination purposes.

A refractive index difference between the core of the scattering particles B and the matrix plastic A in the range 0.09-0.3 and a good distribution of the plastic particles B in the matrix are important for high transparency of the mouldings according to the invention in combination with good visualization of laser beams.

The plastic particles B are core-shell particles, as are readily obtainable by emulsion polymerization (cf. for example DE 198 20 302).

### FIELD OF THE INVENTION

The invention relates to mouldings comprising a transparent plastic matrix having small proportions of incorporated, very finely divided plastic particles which have a particle diameter less than the wavelength of visible light, and to the use of these mouldings for visualizing of laser beams and for illumination purposes.

### PRIOR ART

As a rule, inorganic pigments having high light refraction, such as, for example, titanium dioxide, are used for the whitening of plastics. Although high opacity is generally achieved thereby, this is frequently accompanied by an undesired reduction of the light transmittance.

Organic light-scattering agents, such as, for example, crosslinked plastic particles of a certain particle size having a refractive index differing from the matrix, do not have this disadvantage. Thus, PMMA (n_{D}20=1.49) can be made translucent without significant loss of light transmittance using 3 μm polystyrene particles (n_{D}20=1.59) (DE 2 264 224).

On the other hand, 2.5 μm crosslinked particles based on methacrylate copolymers (n_{D}20=1.485) are suitable for making polystyrene translucent (DE 4231995).

The 2-15 μm particles mentioned in EP 269 324 and having core-shell morphology are particularly suitable for making plastics translucent. These particles, incorporated into a plastic matrix, give mouldings having a high light transmittance; they scatter the light so that the light source is not visible.

Such scattering particles which scatter substantially in a forward direction can advantageously be used for the production of light guide plates which are illuminated from the edge (DE 93 18 362).

Finely divided plastic particles having a rubber core and a rigid shell are widely used as impact modifiers. As a rule, the refractive index of the rubber phase (e.g. polybutyl acrylate) is adapted to the refractive index of the matrix by copolymerization with styrene.

On the other hand, DE 38 42 796 teaches that, in the case of core-shell particles having a rubber particle diameter of <130 nm with a proportion of 10-90% by weight of rubber phase distributed in 90-10% by weight of rigid phase, clear products are obtained even when rubber phase and rigid phase have a refractive index difference of >0.02.

Very recently, regular lattices of latex particles having core-shell morphology have attracted interest, core and shell differing in refractive index, the core being dimensionally stable and the shell being capable of film formation. Such core-shell systems are used for the production of effect paints (DE 198 20 302).

### OBJECT AND ACHIEVEMENT

Although there is a good solution for applications of forward scattering with the abovementioned crosslinked organic polymer particles in the range of a few μm, it is necessary to rely on very finely divided, inorganic white pigments in the range of Raleigh and of Mies scattering, which is of particular interest, for example, for the visualization of a laser beam, with the associated difficulties, such as abrasiveness, sedimentation, poor dispersibility in the plastic matrix or even degradation of the polymer matrix, as is reported for particularly finely divided titanium dioxide (DE 195 43 204).

It has now been found that mouldings which consist of a glass-clear matrix plastic A and organic plastic particles B distributed therein and having core-shell morphology are particularly suitable especially for visualizing laser beams, the core of the plastic particles being crosslinked, the shell being at least partly bonded to the core, and the shell material being miscible with the matrix plastic A. The refractive index of the core material of the plastic particles B differs by 0.06-0.4 from the refractive index of the matrix plastic A. Furthermore, the diameter of the core of the plastic particles B is <0.2 μm and the proportion of the plastic particles B, based on the matrix plastic A, accounts for 0.0001-5% by weight.

A refractive index difference between the core of the scattering particles B and the matrix plastic A in the range 0.09-0.3 and a good distribution of the plastic particles B in the matrix are important for high transparency of the mouldings in combination with good visualization of the laser beams.

Of particular importance is the proportion of the plastic particles B in the matrix. Thus, a proportion of 0.001-0.2% by weight, based on the matrix plastic A is important for most applications. Owing to the good distribution in the matrix plastic, the finely divided nature and the proportion of the particles in the ppm range, the mouldings according to the invention are virtually glass-clear and the laser beam is scarcely attenuated but is clearly visible.

Two types of mouldings are of interest.

These are firstly mouldings having a matrix A of polyacrylate and polymethacrylate. These are understood very generally as meaning plastics which are composed of >90% by weight of esters of acrylic acid and methacrylic acid. PMMA (n_{D}20=1.49) may be mentioned as a typical substance for these plastics. Plastic particles B which are combined with a PMMA matrix contain cores having a refractive index of >1.57, as are obtainable by copolymerization of styrene with crosslinking agents. In addition, monomers containing other aromatic groups are also suitable, for example vinylnaphthalene. In this case of a PMMA matrix, PMMA itself, which is at least partly bonded to the core, is suitable as shell material of the particles B (see below).

The second type of the mouldings according to the invention are mouldings having a matrix A of polystyrene, bisphenol polycarbonate, e.g. bisphenol A polycarbonate, or aromatic polyesters, e.g. polyesters of alkylidene terephthalate. In this case, the shell material of the plastic particles B consists of vinyl polymers which are compatible with said matrix polymers A. For example, copolymers of 60 parts of MMA and 40 parts of cyclohexyl methacrylate (DE 36 323 69) or natural polystyrene itself are suitable as shell material for a matrix of polystyrene.

A copolymer of MMA and phenyl methacrylate, which is compatible with this polycarbonate, is suitable as shell material for the plastic particles B for mixing with bisphenol A polycarbonate (DE 37 192 39). In this case, copolymers of styrene and MMA are also suitable as shell material. These shell materials can also be used for a plastic matrix of aromatic polyesters.

In the case of this aromatic plastic matrix having a comparatively high refractive index, e.g. n_{D}20>1.57, cores of the polymer particles having as low a refractive index as possible are chosen. For example, crosslinked PMMA (n_{D}20=1.49), crosslinked polybutyl acrylate (n_{D}20=1.466) and furthermore cores based on partly fluorinated (meth)acrylates are suitable as core material in this case.

The plastic particles B

The plastic particles B are core-shell particles, as are readily obtainable by emulsion polymerization (cf. for example DE 198 20 302). In principle, these plastic particles consist of 2 different polymers having correspondingly different functions.

The core of the particles, which differs from the matrix plastic with respect to the refractive index, is the light-scattering element and the shell is responsible for good distribution and anchoring of the particles in the matrix. With regard to the light-scattering function, the core is substantially characterized by the difference in the refractive index from the matrix material An and by the size. An is in the range 0.06-0.4, preferably in the range 0.09-0.3. As a rule, the cores are spherical particles having a diameter in the range 0.02-0.2 μm, preferably in the range 0.04-0.15 μm. Cores of the plastic particles Bl for mixing with the matrix plastic A1 poly(meth)acrylate comprise as a rule >60, preferably >90, % by weight of styrene or other aromatic vinyl monomers and 0.01-30% by weight, preferably 0.05-5% by weight, of polyfunctional vinyl compounds (crosslinking agents) such as, for example divinylbenzene or ethylene dimethacrylate.

The concomitant use of a small proportion, e.g. 0.01-10% by weight, of crosslinking agents having 2 polymerizable groups of different reactivity (graft-linking agents), e.g. allyl methacrylate is preferred. These graft-linking agents are important for good binding of the shell to the core.

The shell of the plastic particles B1 for mixing with PMMA preferably comprises MMA and small proportions, e.g. 4% by weight, of C1-C4-esters of acrylic acid for reducing the tendency to depolymerization. As a rule, the polymerization of the shell is effected by the emulsion or monomer feed process, it also being possible to use polymerization regulators, such as, for example, mercaptans, concomitantly, this improving the fusibility of the shell and facilitating the distribution of the particles in the matrix.

If plastic particles having a core with a high refractive index are preferably used for mixing with the plastic matrix Al (PMMA), plastic particles having a low refractive index, n_{D}20 e.g. <1.50, are accordingly chosen for mixing with the more highly retractive aromatic matrix plastics A2. Suitable core materials of the plastic particles B2 are obtained, for example, by copolymerization of >80 parts of MMA, 1-19 parts of acrylates, such as ethyl acrylate, and 0.1-10 parts of crosslinking agents, such as butanediol diacrylate.

As described above, vinyl polymers which are compatible with the plastic matrix A2 are used as shell material. Thus, a shell material comprising 90 parts of MMA and 10 parts of phenyl methacrylate is used, for example, for a plastic matrix A2 comprising polycarbonate (DE 37 192 39).

In general, the weight ratio of core to shell is in the range of 3:1 to 1:10, preferably in the range of 2:1 to 1:5.

The core of the plastic particles B is crosslinked and dimensionally stable. Cores having a glass transition temperature of >60° C. are preferred.

The production of the mouldings from matrix plastic A and plastic particles B

The combination of plastic matrix A and plastic particles B can be carried out by 2 fundamentally different processes.

One of these processes is the casting process. In this process, the plastic particles B are isolated from the aqueous latex as a solid and dispersed in the monomer mixture forming the plastic matrix A. The particle-monomer mixture thus obtained is finally poured into a mould and polymerized.

This process is suitable, for example, for a plastic matrix comprising polyacrylate or polymethacrylate. This process is of particular interest if it is intended to produce crosslinked mouldings, for example flexible mouldings of crosslinked polybutyl acrylate. (For the production of mouldings according to the invention comprising PMMA according to this process, cf. Example 3; for carrying out polymerizations by the casting process, cf. for example Kunststoff-Handbuch [Plastics Handbook] IX, page 15, Carl Hanser Verlag 1975).

The second method for mixing plastic particles B and the plastic matrix A consists in isolating the plastic particles B from the latex and mixing them with moulding material comprising matrix plastic A. The customary moulding materials used for extrusion or injection moulding are used as matrix plastic moulding materials, for example the injection moulding material Plexiglas® 7N from Röhm GmbH in the case of the matrix plastic PMMA for injection moulding purposes.

The isolation of the plastic particles B from the latex is effected by the customary methods, for example by spray-drying, coagulation with polyvalent ions or freeze coagulation. As early as this stage of the isolation of the solid comprising plastic particles B, at least part of the matrix moulding material can be added in the form of a moulding material A latex (for the preparation of moulding material by emulsion polymerization, cf. DE 36 12 791). This facilitates the distribution of the plastic particles in the matrix plastic.

Squeezing moulding material A latex together with plastic particles B latex by means of an extruder is particularly preferred (to carry out this process, cf. DE 29 17 321). This firstly guarantees a good distribution of the plastic particles in the matrix and secondly avoids problems of dust formation, as may occur, for example, in the handling of a solid comprising spray-dried plastic particles B.

Particularly for the production of mouldings having a small proportion of plastic particles in the matrix, mixing in two stages is advisable. Thus, for example, granules of thermoplastically processable matrix plastic A with 1% by weight of plastic particles B are produced in a first stage, and a moulding comprising 99.99% by weight of moulding material matrix A and 0.01% by weight of plastic particles B is then produced therefrom by mixing with moulding material granules by means of injection moulding. The customary mould release agents, anti-ageing agents, etc. are used during the processing.

### Advantageous Effects of the Mouldings According to the Invention

The mouldings according to the invention are as a rule transparent and have a light transmittance of, for example, >80%. In contrast to the highly light-transmitting, white mouldings modified with large plastic particles, the mouldings according to the invention are highly transparent. It is possible to see through them without problems. At any rate, the mouldings have a slightly blue tinge, caused by the increased scattering of the short-wave light components (sky blue).

Mouldings of pure matrix plastic A are optically empty, a light beam is not visible in this matrix, and a light beam is at best perceived through its component reflected at the interfaces of the moulding. On the other hand, a light beam in the mouldings according to the invention is visible in an excellent manner. In a certain way, the plastic particles B in the matrix A constitute an intended, homogeneously distributed impurity which scatters the light.

Starting from white light, a distance-dependent colour is found owing to the dispersion, and the less scattered red light will penetrate further into the moulding than the blue light already strongly scattered in the region of incidence of the light. In this way, it is possible to obtain interesting optical effects. Also interesting is the combination of matrix plastic free of plastic particles with matrix plastic containing plastic particles in a moulding. For example, this enables the lighting industry to combine luminous and optically empty regions in a targeted manner.

However, the main application of the mouldings according to the invention lies in the combination of the mouldings according to the invention with light of narrow wavelength distribution, in particular in the combination with lasers or laser diodes.

The mouldings according to the invention are of particular interest in the area of safety applications. Thus, a laser beam can be made readily visible by the mouldings without significantly attenuating it. This makes it possible to follow the beam path easily. In addition, the mouldings according to the invention are used in the area of measuring technology, for example as an aid for laser levels. For many of these applications, the mouldings should have 2 plane parallel surfaces so that the laser beam is not changed in its path by the moulding.

A further application is in the area of teaching. Particularly suitable here are mouldings having a thickness of >1 mm, most preferably having a thickness in the range of 3-8 mm, in which at least 1 part of the moulding is in the form of a segment of a circle. On inputting the laser beam via the edge of the segment of the circle (cf. also Example 5), it is possible to demonstrate properties of light, such as refraction, reflection and total reflection, in a simple manner using the path of the laser beam in these mouldings.

The customary, commercially available lasers or laser diodes of the wavelength range of 0.4-0.8 μm are used here, in particular red light lasers, for example lasers of wavelength 650 nm, being of interest. Such systems are widely used, for example, as laser pointers.

Another field of use of the mouldings according to the invention is the area of illumination with light having a narrow distribution or monochromatic light. Thus, these mouldings can be used as edge-illuminated light guide elements for monochromatic light. It is of interest that the plastic particles distributed in the matrix are very finely divided so that these mouldings can also be produced as very thin films. For the use of this edge-illuminated sheet-like lighting element as a vehicle rear light or as a brake light, it is advantageous to metallize the back of this element.

Of particular interest in relation to these novel, sheet-like lighting elements equipped, for example, with laser diodes at an edge is the circumstance that the light emanating from these elements is polarized. This light can therefore be distinguished from the light emanating from another light source.

The following examples are intended to explain the invention but do not constitute a limitation.

### EXAMPLE 1

### Synthesis of a Plastic Particle Latex

40 mg of sodium hydroxide, 160 mg of sodium bicarbonate and 0.57 g of sulphosuccinic acid bis(2-ethylhexyl) ester sodium salt 98% (Aldrich) in 655 g of distilled water are initially introduced into a 1 l stirred vessel while passing through argon as inert gas. Half of the monomer mixture (M-core) , consisting of 39.2 g of styrene and 3.8 g of allyl methacrylate, is added and the polymerization is initiated at 70° C. by adding 0.5 g of potassium peroxodisulphate in 30 g of water. After 30 minutes, cooling to 50° C. is effected, the 2nd half of the monomer mixture (M-core) is added and the mixture is heated to 70° C. again. After 30 minutes, the monomer mixture (M-shell), consisting of 61.8 g of MMA and 1.3 g of ethyl acrylate, is metered in over a period of 15 minutes. Thereafter, stirring is continued for a further 15 minutes at 70° C. and the mixture is finally heated to 90° C. for 45 minutes. A finely divided dispersion results after cooling. Solids content: 13.5%. Diameter of the core about 100 nm.

### EXAMPLE 2

### Isolation of the Solid Comprising Plastic Particles

The plastic particle latex according to Example 1 is frozen at −20° C. and thawed with water at 80° C. After the coagulated solid has been filtered off with suction and dried at 30° C., a pulverulent solid results.

### EXAMPLE 3

### Synthesis of a Moulding by the Casting Process

Moulding matrix based on PMMA with 0.033% by weight of plastic particles B

30 mg of the solid comprising plastic particles according to Example 2 are dispersed in 29.97 g of MMA by means of an overhead mixer. A homogeneous, whitish, storage-stable dispersion is obtained.

Two parts of a solution of 0.1% by weight of AIBN and 2% by weight of dodecanethiol in MMA are added to 1 part of this dispersion, degassing is effected and the mixture is introduced into a test tube and polymerized under argon at 50-70° C. in a water bath. After the end of the polymerization and heating, the test tube is broken. A transparent moulding having a slightly blue tinge in the shape of the test tube is obtained. If the beam of a laser pointer (650 nm) is allowed to enter the moulding from below (the bottom of the test tube whose shape has been taken), a sharp laser beam is observed, which very elegantly visualizes the total reflection and the light conduction in this rod-like plastic glass body. The laser beam is not perceptibly attenuated even after a distance of 5 cm.

### EXAMPLE 4

### Synthesis of a Plastic Particle Masterbatch for Mixing with Standard Moulding Material

25 g of the solid comprising plastic particles according to Example 2 are mixed with 975 g of MMA in a glass bottle using an overhead mixer. A homogeneous, storage-stable, white dispersion of 2.5% by weight of plastic particles B in MMA is obtained.

This dispersion is added to a solution of 0.5 g of AIBN, 1.5 g of tert-butyl peroxybenzoate and 8.0 g of dodecanethiol in 170 g of MMA. The mixture obtained is introduced into a polymerization chamber, degassed for 10 min and polymerized in a water bath at 50-60° C. Thereafter, heating is effected at 110° C. and finally milling is effected in a mill.

### EXAMPLE 5

### Production of a Moulding According to the Invention by Injection Moulding

1 part of the milled plastic particle masterbatch according to Example 4 is mixed with 40 parts of a milled PMMA injection moulding material, e.g. Altuglas V920 CLEAR 100, and injected into an injection moulding machine. In this way, injection mouldings are obtained: 6 mm thick semicircles (radius: 30 mm). These small semicircular plates are transparent and have a slightly blue tinge. If the light of a red laser (650 nm) is allowed to enter these plates via the edge on the circular side, perpendicular to the surface of the circle, the path of this light beam can be readily followed and the emergence of the light beam or the reflection thereof can be very easily observed on the straight side and the angle of the total reflection estimated.

1. A moulding composition consisting of:
a matrix plastic A; and
plastic particles B distributed in the matrix plastic A and having a core-shell morphology, the core of the plastic particles B being crosslinked, the shell of the plastic particles B being at least partly bonded to the core of the plastic particles B, and the shell of the plastic particles B being miscible with the matrix plastic A,
wherein the refractive index of the core of the plastic particles B differs by 0.06-0.4 from the refractive index of the matrix plastic A,
wherein the diameter of the core of the plastic particles B is <0.2 μm, and
wherein the proportion of the plastic particles B, based on the matrix plastic A, is 0.0001-5% by weight.

2. The moulding composition according to claim 1, wherein the matrix plastic A is selected from the group consisting of polyacrylates and polymethacrylates, and the core of the plastic particles B comprises aromatic groups and has a refractive index of >1.57.

3. The moulding composition according to claim 1, wherein the matrix plastic A comprises aromatic groups and is selected from the group consisting of polystyrenes, polycarbonates and polyesters, and the core of the plastic particles B has a refractive index of <1.50.

4. The moulding composition according to claim 1, wherein the proportion of the plastic particles B, based on the matrix plastic A, is 0.001-0.2% by weight.

5. The moulding composition according to claim 1, wherein the moulding composition is in the form of a film.

6. The moulding composition according to claim 1, wherein the moulding composition has at least two plane parallel flat surfaces.

7. The moulding composition according to claim 1, wherein the moulding composition has a thickness of >1 mm and at least a part of the moulding composition is in the form of a segment of a circle.

8. An edge-illuminated light guide element comprising the moulding composition according to claim 1.

9. A vehicle rear light or brake light comprising the moulding composition according to claim 1.

10. A laser beam visualizer comprising the moulding composition according to claim 1.

11. A light refraction and light conduction demonstrator comprising the moulding composition according to claim 1.
